(19) United States
(12) Patent Application Publication
(10) Pub. No.: US 2025/0321374 A1
(43) Pub. Date: Oct. 16, 2025

(54) OPTICAL INTEGRATED DEVICE, OPTICAL TRANSMISSION DEVICE, AND OPTICAL TRANSCEIVER

(71) Applicant: FUJITSU OPTICAL COMPONENTS LIMITED, Kawasaki-shi (JP)

(72) Inventor: Masaki SUGIYAMA, Kawasaki (JP)

(73) Assignee: FUJITSU OPTICAL COMPONENTS LIMITED, Kawasaki-shi (JP)

(21) Appl. No.: 19/038,046

(22) Filed: Jan. 27, 2025

(30) Foreign Application Priority Data
Apr. 11, 2024 (JP) 2024-064289

(51) Int. Cl. G02B 6/12; G02B 6/125; G02B 6/126

(52) U.S. Cl. CPC G02B 6/12004; G02B 6/125; G02B 6/126; G02B 2006/1204; G02B 2006/12061; G02B 2006/12085; G02B 2006/12097; G02B 2006/12116; G02B 2006/12142; G02B 2006/12164

(57) ABSTRACT

An optical integrated device includes a first chip having a step portion, and a second chip that is mounted on the step portion, and that is optically connected to the first chip. The first chip includes an optical waveguide including a material having a high electro-optic effect compared to a material of the second chip. The optical integrated device includes a first inclined surface that is formed on a wall surface on a side on which the optical waveguide and the second chip are optically connected in the step portion, and a second inclined surface that is formed on an end surface of the second chip on a side on which it is mounted within the step portion, and that abuts on the first inclined surface facing the first inclined surface.

### CROSS-REFERENCE TO RELATED APPLICATION

This application is based upon and claims the benefit of priority of the prior Japanese Patent Application No. 2024-064289, filed on Apr. 11, 2024, the entire contents of which are incorporated herein by reference.

### FIELD

The embodiments discussed herein are related to an optical integrated device, an optical transmission device, and an optical transceiver.

### BACKGROUND

FIG. 14 is a plan schematic diagram illustrating an example of an optical integrated device 200, and FIG. 15 is a simplified cross-section schematic diagram illustrating an example of the optical integrated device 200. For convenience of explanation, the simplified cross-section schematic diagram is a schematic cross-section of the optical integrated device 200 illustrated in FIG. 14. The optical integrated device 200 includes an optical modulator chip 210, a micro lens array (MLA) 221, a polarization rotator (PR) 222, a polarization beam combiner (PBC) 223, and an optical fiber array 230. The optical modulator chip 210 is, for example, a thin-film LiNbO₃ (TF-LN) modulator chip. The optical modulator chip 210 includes a TF-LN optical waveguide 211, a TF-LN optical modulator 212, an input unit 213, a first output unit 214A, and a second output unit 214B. On a chip end surface 210A of the optical modulator chip 210, the input unit 213, the first output unit 214A, and the second output unit 214B are arranged.

The optical waveguide 211 in the optical modulator chip 210 includes an input waveguide 211A, a folded waveguide 211B, a first output waveguide 211C1, and a second output waveguide 211C2. The input waveguide 211A is a TF-LN waveguide that linearly extends in a longitudinal direction of the optical modulator chip 210 from the input unit 213 of the optical modulator chip 210. The folded waveguide 211B is a TF-LN waveguide that folds back from the input waveguide 211A and connects to an input stage of the optical modulator 212. The first output waveguide 211C1 is a F-LN waveguide that connects an output stage of the optical modulator 212 and the first output unit 214A of the optical modulator chip 210. The second output waveguide 211C2 is a TF-LN waveguide that connects the output stage of the optical modulator 212 and the second output unit 214B of the optical modulator chip 210.

The optical modulator 212 includes an optical waveguide and an electrode that applies an electrical signal to the optical waveguide, and optically modulates light passing through the optical waveguide by applying an electrical signal from the electrode. The optical fiber array 230 includes an optical fiber 231A on a input side for inputting light and an optical fiber 231B on an output side for outputting light.

The MLA 221 is an optical component connected to a chip end surface 210A of the optical modulator chip 210 that optically couples the TF-LN optical waveguide 211 and the optical fiber array 230. The MLA 221 is connected to the optical fiber 231A on the input side in the optical fiber array 230, and inputs light from the optical fiber 231A on the input side to the input waveguide 211A. The MLA 221 outputs a TE-polarized signal light from the optical modulator 212 to the PR 222 and the PBC 223. The PR 222 rotates the polarization of the signal light from the optical modulator 212 by 90 degrees through the MLA 221 and outputs the TM-polarized signal light after polarization rotation to the PBC 223. The PBC 223 subjects the TE-polarized signal light obtained from the optical modulator 212 through the MLA 221 and the TM-polarized signal light after polarization rotation to polarization multiplexing, and outputs the signal light subjected to the polarization multiplexing to the optical fiber 231B on the output side in the optical fiber array 230 (U.S. Pat. No. 6,510,258, U.S. Patent Application Publication No. 2013/0163916, Japanese Laid-Open Patent Publication Nos. 8-327841, 2012-98472).

In the optical integrated device 200, optical axes of the optical waveguide 211 on the chip end surface 210A of the optical modulator chip 210 and the MLA 221 are aligned, and the optical modulator chip 210 and the MLA 221 are fixed using an adhesive A. Subsequently, an alignment work includes a work to align the optical axes of the PR 222, the PBC 223, and the optical fiber array 230 with respect to the MLA 221.

However, because the optical waveguide 211 in the optical modulator chip 210 is a TF-LN optical waveguide having an electro-optic effect, an optical mode field diameter is small, and a high-precision alignment work is expected. Consequently, a workload for implementing chips equipped with an optical waveguide having an electro-optic effect increases.

### SUMMARY

According to an aspect of an embodiment, an optical integrated device includes a first chip having a step portion, and a second chip that is mounted on the step portion, and that is optically connected to the first chip. The first chip includes an optical waveguide including a material having a high electro-optic effect compared to a material of the second chip. The optical integrated device includes a first inclined surface that is formed on a wall surface on a side on which the optical waveguide and the second chip are optically connected in the step portion, and a second inclined surface that is formed on an end surface of the second chip on a side on which it is mounted within the step portion, and that abuts on the first inclined surface facing the first inclined surface.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a plan schematic diagram illustrating an example of an optical integrated device according to a first embodiment;

FIG. 2 is a simplified cross-section schematic diagram illustrating an example of the optical integrated device;

FIG. 3 is a plan schematic diagram illustrating an example of an optical integrated device according to a second embodiment;

FIG. 4 is a simplified cross-section schematic diagram illustrating an example of the optical integrated device;

FIG. 5 is a plan schematic diagram illustrating an example of an optical integrated device according to a third embodiment;

FIG. 6 is a simplified cross-section schematic diagram illustrating an example of the optical integrated device;

FIG. 7 is a plan schematic diagram illustrating an example of an optical integrated device according to a fourth embodiment;

FIG. 8A is a simplified cross-section schematic diagram cut along a line A-A in FIG. 7;

FIG. 8B is a simplified cross-section schematic diagram cut along a line B-B in FIG. 7;

FIG. 9 is a plan schematic diagram illustrating an example of an optical integrated device according to a fifth embodiment;

FIG. 10A is a simplified cross-section schematic diagram cut along a line A-A in FIG. 9;

FIG. 10B is a simplified cross-section schematic diagram cut along a line B-B in FIG. 9;

FIG. 11 is an explanatory diagram illustrating an example of an optical transceiver according to the present embodiment;

FIG. 12 is a plan schematic diagram illustrating an example of an optical integrated device according to a comparative example;

FIG. 13 is a simplified cross-section schematic diagram illustrating an example of the optical integrated device according to the comparative example;

FIG. 14 is a plan schematic diagram illustrating an example of an optical integrated device; and

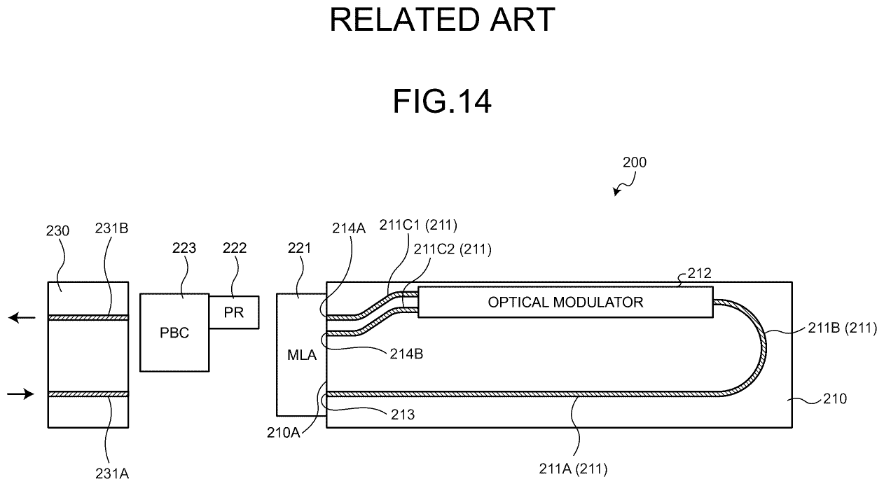

FIG. 15 is a simplified cross-section schematic diagram illustrating an example of the optical integrated device;

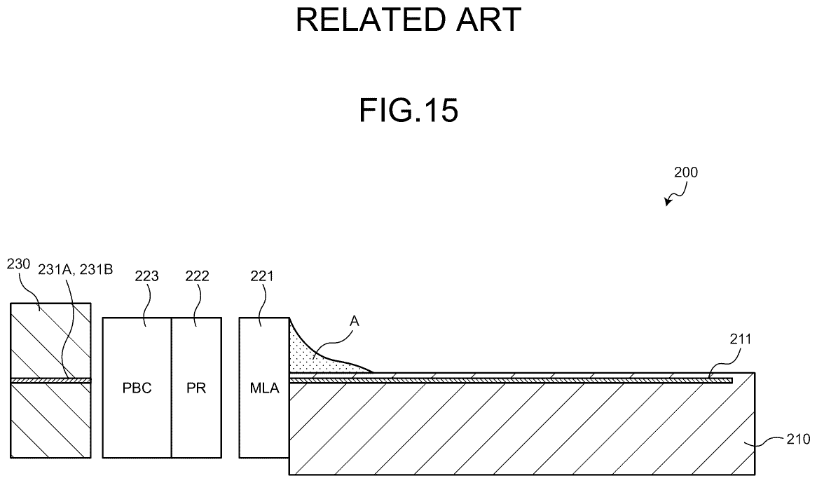

### DESCRIPTION OF EMBODIMENTS

First, an optical integrated device according to a comparative example that can reduce the workload for implementing a chip equipped with an optical waveguide having an electro-optic effect will be explained.

### Comparative Example

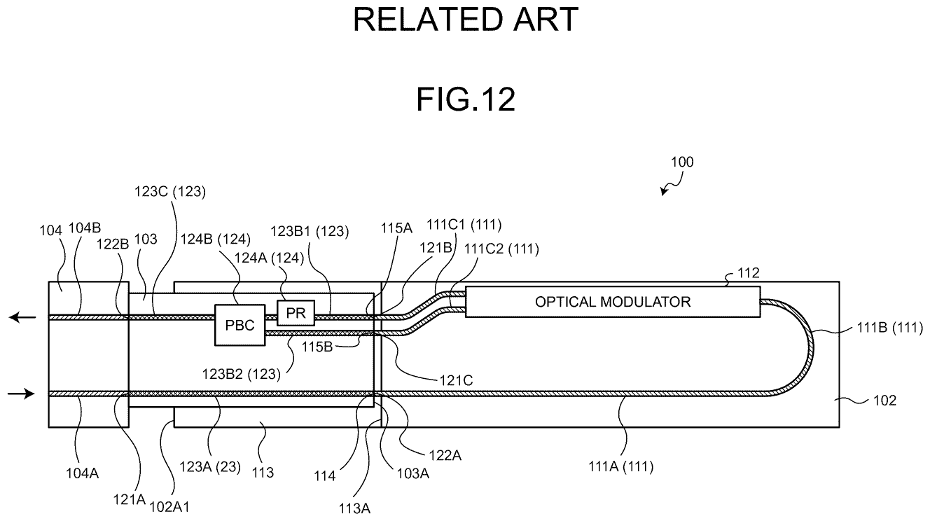

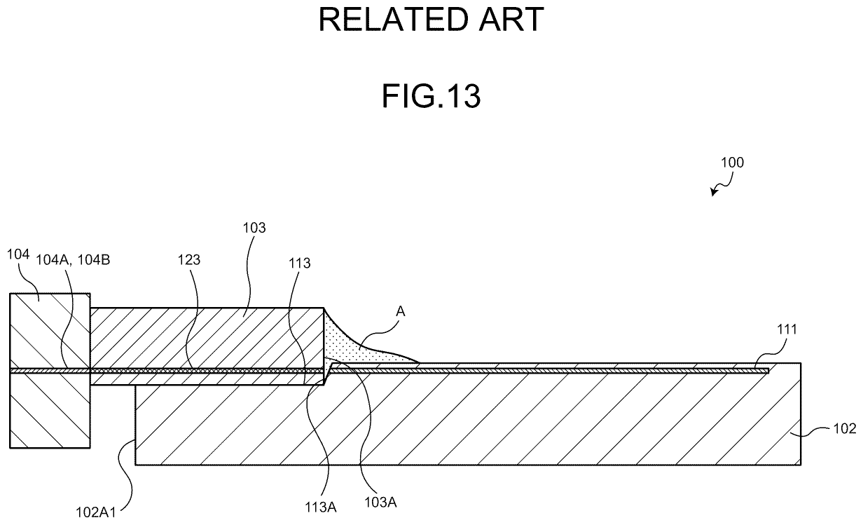

FIG. 12 is a plan schematic diagram illustrating an example of an optical integrated device 100 according to a comparative example, and FIG. 13 is a simplified cross-section schematic diagram illustrating an example of the optical integrated device 100 according to the comparative example. For convenience of explanation, the simplified cross-section schematic diagram is a schematic cross-section of the optical integrated device 100. The optical integrated device 100 includes a first chip 102 equipped with a first optical waveguide 111 having an electro-optic effect, a second chip equipped with an optical circuit 124 and a second optical waveguide 123, and an optical fiber array 104. The first chip 102 is a chip having an electro-optic effect, such as a TF-LN. The first chip 102 is an LN thin-film substrate of a submicron thickness. A second chip 103 is, for example, a silicon photonics (SiPh) chip. The optical fiber array 104 includes an optical fiber 104A on an input side to input light and an optical fiber 104B on an output side to output light.

The first chip 102 includes a first optical waveguide 111 formed using a TF-LN material, an optical modulator 112 formed using a TF-LN material, a step portion 113 formed on a chip end surface 102A, an input unit 114, a first output unit 115A, and a second output unit 115B. The step portion 113 is formed on the chip end surface 102A1 of the first chip 102, and has a terrace structure for mounting the second chip 103. The input unit 114 is arranged on an inclined surface 113A of the step portion 113, and is a portion to input light from the second optical waveguide 123 of the second chip 103. The inclined surface 113A is a surface facing a bonding surface 103A of the second chip 103 described later. The first output unit 115A and the second output unit 115B are components that are arranged on the inclined surface 113A of the step portion 113, and that output a signal light from the optical modulator 112 to the second optical waveguide 123 of the second chip 103.

The first optical waveguide 111 includes an input waveguide 111A, a folded waveguide 111B, a first output waveguide 111C1, and a second output waveguide 111C2. The input waveguide 111A is a linear TF-LN optical waveguide that extends in a longitudinal direction of the first chip 102 from the input unit 114, and that is connected to the folded waveguide 111B. The folded waveguide 111B is a folded TF-LN waveguide that is connected to the input waveguide 111A and an input stage of the optical modulator 112. The first output waveguide 111C1 is a TF-LN waveguide that connects an output stage of the optical modulator 112 and the first output unit 115A. The second output waveguide 111C2 is a TF-LN waveguide that connects the output stage of the optical modulator 112 and the second output unit 115B.

The second chip 103 includes a first input unit 121A, a second input unit 121B, a third input unit 121C, a first output unit 122A, a second output unit 122B, the second optical waveguide 123, and the optical circuit 124. The optical circuit 124 includes a PR 124A formed using an Si material and a PBC 124B formed using an Si material. The first input unit 121A is a component that is arranged on a surface connected to the optical fiber array 104, and that inputs light from the optical fiber 104A on the input side in the optical fiber array 104. The first output unit 122A is a component that is arranged on the bonding surface 103A facing the inclined surface 113A of the first chip 102, and that outputs light from the first input unit 121A to the first chip 102. The second input unit 121B is a component that is arranged on the bonding surface 103A facing the inclined surface 113A of the first chip 102, and that inputs light from the optical modulator 112 in the first chip 102 to the PR 124A. The third input unit 121C is a component that is arranged on the bonding surface 103A facing the inclined surface 113A of the first chip 102, and that inputs light from the optical modulator 112 in the first chip 102 to the PBC 124B. The second output unit 122B is a component that is arranged on a surface connected to the optical fiber array 104, and that outputs a signal light from the PBC 124B to the optical fiber 104B on the output side in the optical fiber array 104.

The second optical waveguide 123 includes an input waveguide 123A, a first input waveguide 123B1, a second input waveguide 123B2, and an output waveguide 123C. The input waveguide 123A is an Si waveguide that connects between the first input unit 121A and the first output unit 122A. The first input waveguide 123B1 is an Si waveguide that connects between the second input unit 121B and the PR 124A. The second input waveguide 123B2 is an Si waveguide that connects between the third input unit 121C and the PBC 124B. The output waveguide 123C is an Si waveguide that connects between the second output unit 122B and the PBC 124B.

The PR 124A is a polarization rotating unit that converts a TE-polarized signal light from the first input waveguide 123B1 into a TM-polarized signal light by rotating the polarization by 90 degrees, and that outputs the TM-polarized signal light to the PBC 124B. The PBC 124B is a polarization multiplexing unit that polarization-multiplexes the TE-polarized signal light from the second input waveguide 123B2 and the TM-polarized signal light after polarization rotation from the PR 124A, and that outputs the polarization-multiplexed signal light to the output waveguide 123C.

At a portion near the chip end surface 102A1 of the first chip 102, the step portion 113 having a terrace structure to mount the second chip 103, for example, in a face-down manner is arranged. Because the step portion 113 is formed, for example, by etching to recess a surface of the first chip 102, a wall surface of the step portion 113 forms the inclined surface 113A. On the inclined surface 113A, as described previously, the first output unit 122A, the first input unit 121A, and the second input unit 121B are arranged.

When the second chip 103 is mounted face-down in the step portion 113 of the first chip 102, the first optical waveguide 111 of the first chip 102 and the second optical waveguide 123 of the second chip 103 are optically coupled by butt coupling using an adhesive A. As a result, the input unit 114 of the first chip 102 and the first output unit 122A in the second chip 103 are optically connected. Furthermore, the first output unit 115A in the first chip 102 and the second input unit 121B in the second chip 103 are optically connected, and the second output unit 115B in the first chip 102 and the third input unit 121C in the second chip 103 are optically connected.

Furthermore, as the second chip 103 is connected to the optical fiber array 104 with the adhesive A, the first input unit 121A and the optical fiber 104A on the input side are optically connected, and the second output unit 122B and the optical fiber 104B on the output side are optically connected.

In the optical integrated device 100, on the step portion 113 in the first chip 102 having an electro-optic effect, the second chip 103 equipped with the optical circuit 124 is amounted. The optical integrated device 100 optically couples the first optical waveguide 111 on the inclined surface 113A of the first chip 102 and the second optical waveguide 123 on the bonding surface 103A of the second chip 103 by butt coupling. As a result, it becomes unnecessary to mount components of the PR 124A and the PBC 124B individually and, consequently, the number of parts can be reduced, and the work load for implementation in the first chip 102 having an electro-optic effect can be significantly reduced.

In the optical integrated device 100, because the wall surface of the step portion 113 of the first chip 102 is the inclined surface 113A, a gap occurs between the inclined surface 113A of the first chip 102 and the bonding surface 103A of the second chip 103. By applying the adhesive A to this gap, the second optical waveguide 123 and the first optical waveguide 111 are optically coupled. However, in the optical integrated device 100, the gap between the inclined surface 113A and the bonding surface 103A is large. Therefore, light emitted from the bonding surface 103A of the second chip 103 diverges in the adhesive A applied to this gap, and the optical coupling efficiency between the second optical waveguide 123 and the first optical waveguide 111 decreases.

Therefore, an embodiment of an optical integrated device that can improve the optical coupling efficiency between the second optical waveguide 123 and the first optical waveguide 111 will be explained below as a first embodiment. The present embodiment is not intended to limit the disclosed technique. Moreover, respective embodiments described below may be appropriately combined within a range not causing a contradiction.

### (a) First Embodiment

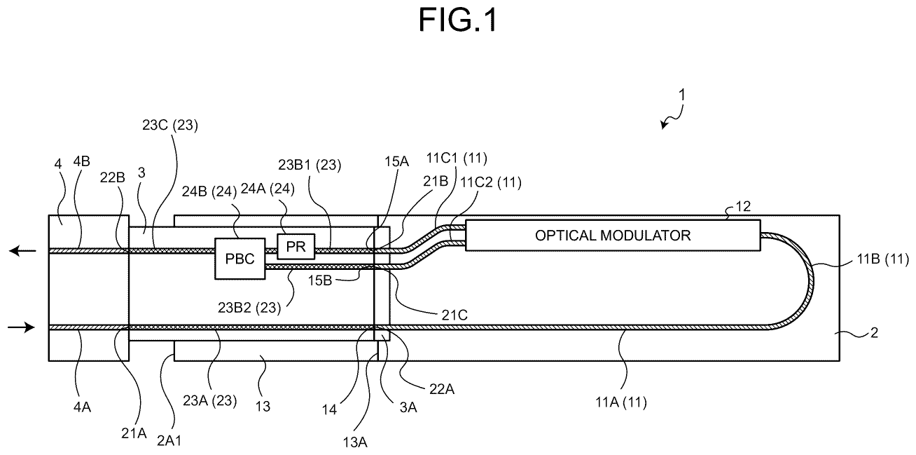

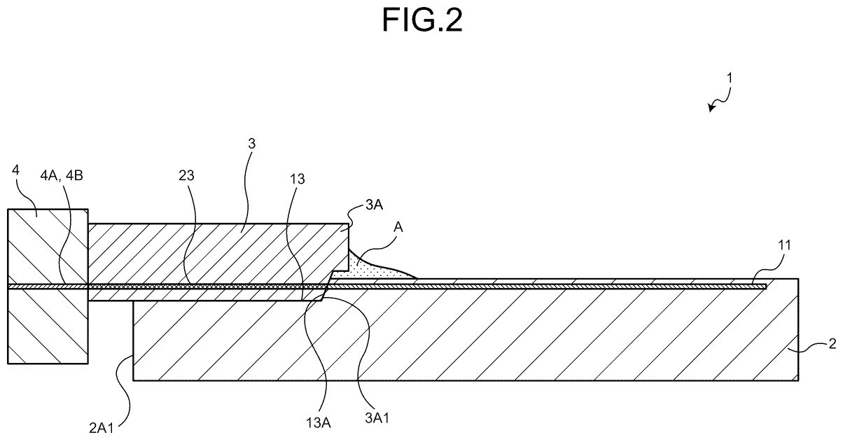

FIG. 1 is a plan schematic diagram illustrating an example of an optical integrated device 1 according to the first embodiment, and FIG. 2 is a simplified cross-section schematic diagram illustrating an example of the optical integrated device 1. For convenience of explanation, the simplified cross-section schematic diagram is a schematic cross-section of the optical integrated device 1. The optical integrated device 1 includes a first chip 2 equipped with a first optical waveguide 11 having an electro-optic effect, a second chip 3 equipped with an optical circuit 24 and a second optical waveguide 23, and an optical fiber array 4. The first chip 2 is, for example, a chip having an electro-optic effect, such as a TF-LN. The first chip 2 is an LN thin-film substrate of a submicron thickness. The second chip 3 is, for example, a silicon photonics (SiPh) chip. The optical fiber array 4 includes an optical fiber 4A on an input side to input light and an optical fiber 4B on an output side to output light.

The first chip 2 includes a first optical waveguide 11 formed using a TF-LN material, an optical modulator 12 formed using a TF-LN material, a step portion 13 formed on a chip end surface 2A1, an input unit 14, a first output unit 15A, and a second output unit 15B. The step portion 13 is formed on the chip end surface 2A1 of the first chip 2, and has a terrace structure for mounting the second chip 3. The input unit 14 is arranged on a first inclined surface 13A of the step portion 13, and is a portion to input light from the second optical waveguide 23 of the second chip 3. The first inclined surface 13A is a surface inclined relative to a perpendicular direction of a surface of the step portion 113. The first inclined surface 13A is a surface abutting on a second inclined surface 3A1 of the second chip 3 described later. The first output unit 15A and the second output unit 15B are components that are arranged on the first inclined surface 13A of the step portion 13, and that output a signal light from the optical modulator 12 to the second optical waveguide 23 of the second chip 3.

The first optical waveguide 11 includes an input waveguide 11A, a folded waveguide 11B, a first output waveguide 11C1, and a second output waveguide 11C2. The input waveguide 11A is a linear TF-LN optical waveguide that extends in a longitudinal direction of the first chip 2 from the input unit 14, and that is connected to the folded waveguide 11B. The first inclined surface 13A is a wall surface to which an input end of the input waveguide 11A extends. The folded waveguide 11B is a folded TF-LN waveguide that is connected to the input waveguide 11A and an input stage of the optical modulator 12. The first output waveguide 11C1 is a TF-LN waveguide that connects an output stage of the optical modulator 12 and the first output unit 15A. The second output waveguide 11C2 is a TF-LN waveguide that connects the output stage of the optical modulator 12 and the second output unit 15B. The first inclined surface 13A is a wall surface to which output ends of the first output waveguide 11C1 and the second output waveguide 11C2 extend.

The second chip 3 includes a first input unit 21A, a second input unit 21B, a third input unit 21C, a first output unit 22A, a second output unit 22B, a second optical waveguide 23, and an optical circuit 24. The optical circuit 24 includes a PR 24A formed by using an Si material, and a PBC 24B formed using an Si material. The second chip 3 has a distal-end step portion 3A formed by etching and recessing an area near a lower part of a chip end face mounted on the step portion 13. Furthermore, the second chip 3 has a second inclined surface 3A1 that is formed to be inclined by etching and recessing a lower part of the distal-end step portion 3A and that abuts on the first inclined surface 13A of the step portion 13. The second inclined surface 3A1 is a surface inclined relative to a perpendicular direction of a chip surface. The second inclined surface 3A1 of the second chip 3 has the same direction of inclination with the first inclined surface 13A of the first chip 2.

The first input unit 21A is a component that is arranged on a surface connected to the optical fiber array 4, and that inputs light from the optical fiber 4A on the input side in the optical fiber array 4. The first output unit 22A is a component that is arranged on the second inclined surface 3A1 abutting on the first inclined surface 13A of the first chip 2, and that outputs light from the first input unit 21A to the first chip 2. The second input unit 21B is a component that is arranged on the second inclined surface 3A1 abutting on the first inclined surface 13A of the first chip 2, and that inputs light from the optical modulator 12 in the first chip 2 to the PR 24A. The third input unit 21C is a component that is arranged on the second inclined surface 3A1 abutting on the first inclined surface 13A of the first chip 2, and that inputs light from the optical modulator 12 in the first chip 2 to the PBC 24B. The second output unit 22B is a component that is arranged on a surface connected to the optical fiber array 4, and that outputs a signal light from the PBC 24B to the optical fiber 4B on the output side in the optical fiber array 4.

The second optical waveguide 23 includes an input waveguide 23A, a first input waveguide 23B1, a second input waveguide 23B2, and an output waveguide 23C. The input waveguide 23A is an Si waveguide that connects between the first input unit 21A and the first output unit 22A. The second inclined surface 3A1 is a wall surface to which an output end of the input waveguide 23A extends. The first input waveguide 23B1 is an Si waveguide that connects between the second input unit 21B and the PR 24A. The second input waveguide 23B2 is an Si waveguide that connects between the third input unit 21C and the PBC 24B. The second inclined surface 3A1 is a wall surface to which input ends of the first input waveguide 23B1 and the second input waveguide 23B2 extend. The output waveguide 23C is an Si waveguide that connects between the second output unit 22B and the PBC 24B.

The PR 24A is a polarization rotating unit that converts a TE-polarized signal light from the first input waveguide 23B1 into a TM-polarized signal light by rotating the polarization by 90 degrees, and that outputs the TM-polarized signal light to the PBC 24B. The PBC 24B is a polarization multiplexing unit that polarization-multiplexes the TE-polarized signal light from the second input waveguide 23B2 and the TM-polarized signal light after polarization rotation from the PR 24A, and that outputs the polarization-multiplexed signal light to the output waveguide 23C.

At a portion near the chip end surface 2A1 of the first chip 2, the step portion 13 having a terrace structure to mount the second chip 3, for example, in a face-down manner is arranged. The step portion 13 is formed, for example, by etching to recess a surface of the first chip 2. On the first inclined surface 13A, which is a wall surface of the step portion 13, as described previously, the first output unit 22A, the first input unit 21A, and the second input unit 21B are arranged.

When the second chip 3 is mounted face-down in the step portion 13 of the first chip 2, the second inclined surface 3A1 and the first inclined surface 13A are brought into contact. The gap between the first inclined surface 13A of the first chip 2 and the second inclined surface 3A1 of the second chip 3 becomes small. Subsequently, the first optical waveguide 11 of the first chip 2 and the second optical waveguide 23 of the second chip 3 are optically coupled by butt coupling by using the adhesive A in a state in which the first inclined surface 13A and the second inclined surface 3A1 abut on each other. As a result, the input unit 14 of the first chip 2 and the first output unit 22A in the second chip 3 are optically connected. Furthermore, the first output unit 15A in the first chip 2 and the second input unit 21B in the second chip 3 are optically connected, and the second output unit 15B in the first chip 2 and the third input unit 21C in the second chip 3 are optically connected.

When the second chip 3 is mounted face-down in the step portion 13 of the first chip 2, although a gap occurs between the distal-end step portion 3A and the chip end surface of the first chip 2 as illustrated in FIG. 2, the adhesive A is applied to the gap between the distal-end step portion 3A and the chip end surface of the first chip 2. As a result, the second chip 3 can be mounted in the step portion 13 of the first chip 2 by using the adhesive A in the gap between the distal-end step portion 3A and the chip end surface of the first chip 2.

Furthermore, as the second chip 3 is connected to the optical fiber array 4 with the adhesive A, the first input unit 21A and the optical fiber 4A on the input side are optically connected, and the second output unit 22B and the optical fiber 4B on the output side are optically connected.

In the optical integrated device 1 according to the first embodiment, the first optical waveguide 11 on the first inclined surface 13A and the second optical waveguide 23 on the second inclined surface 3A1 are optically coupled by butt coupling by using the adhesive A in a state in which the second inclined surface 3A1 and the first inclined surface 13A abut on each other. That is, the gap between the second optical waveguide 23 on the second inclined surface 3A1 and the first optical waveguide 11 on the first inclined surface 13A becomes small. As a result, the optical coupling efficiency between the second optical waveguide 23 and the first optical waveguide 11 can be improved.

In the optical integrated device 1, the first optical waveguide 11 of the first chip 2 on which the second chip 3 equipped with the optical circuit 24 is mounted and the second optical waveguide 23 of the second chip 3 are optically coupled by butt coupling on the step portion 13 in the first chip 2 having an electro-optic effect. As a result, it becomes unnecessary to mount components of the PR 124A and the PBC 124B individually and, consequently, the number of parts can be reduced, and the work load for implementation in the first chip 102 having an electro-optic effect can be significantly reduced.

Generally, the LN modulator chip is large in size compared to the SiPh chip, if a step portion is formed on the SiPh chip and the LN modulator is mounted thereon, the size of the SiPh chip is increased to match the size of the LN modulator. On the other hand, in the optical integrated device 1 according to the first embodiment, it is unnecessary to match the size of the second chip 3, which is the SiPh chip, with the size of the first chip 2, which is the LN modulator and, therefore, the unnecessary enlargement of the second chip 3 can be eliminated.

Because the second chip 3 is mounted face-down on the step portion 13 in the first chip 2, the depth of the step portion 13 formed on the first chip 2 can be made shallow. Therefore, it is possible to reduce a load for etching when the step portion 13 is formed.

Because the optical modulator 12 of the first chip 2 is an optical modulator with a TF-LN crystal, by achieving a large electro-optic effect, the driving voltage of the modulator can be reduced.

Because the second chip 3 is an SiPh chip, the size of the optical circuit 24 including the PR 24A and the PBC 24B can be reduced.

For convenience of explanation, a case in which the second chip 3 is mounted face-down on the step portion 13 of the first chip 2 has been presented as an example, but face-up mounting is also acceptable, and it can be modified as appropriate. Because the second optical waveguide 23 is formed near a chip surface in the second chip 3, by making the depth of the step portion 13 deep, face-up mounting of the second chip 3 on the step portion 13 of the first chip 2 is enabled.

Furthermore, while TF-LN has been presented as an example of a material with an electro-optic effect, it is not limited thereto. For example, TF-barium titanate can also be used, and modifications can be made as appropriate. As a material with an electro-optic effect, for example, TF-BTO (BaTiO₃), TF-PLZT (PbLaZrTiO₃), or TF-PZT (PbZrTiO₃) can also be used.

In the optical integrated device 1 according to the first embodiment, an example in which the first optical waveguide in the first chip 2 and the second optical waveguide in the second chip 3 are optically coupled by butt coupling has been presented as an example. However, when a gap X between the input waveguide 11A and the first output waveguide 11C1 in the first optical waveguide 11 in the first chip 2 becomes large, misalignment of an optical axis becomes significant in the case of misalignment of positioning angle of the second chip 3 when mounting the second chip 3 with respect to the first chip 2. As a result, a coupling loss between the first optical waveguide 11 and the second optical waveguide 23 increases. Therefore, an embodiment to address such a situation will be explained below as a second embodiment.

### (b) Second Embodiment

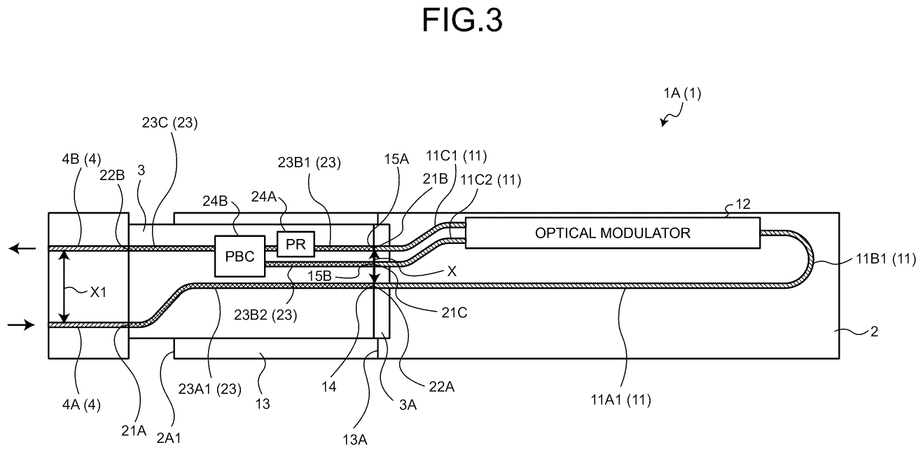

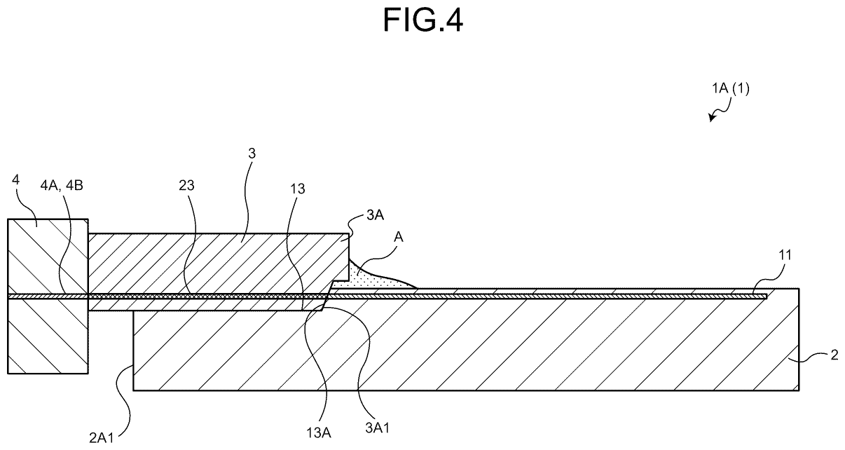

FIG. 3 is a plan schematic diagram illustrating an example of an optical integrated device 1A according to a second embodiment, and FIG. 4 is a simplified cross-section schematic diagram illustrating an example of the optical integrated device 1A. By assigning identical reference symbols to identical components to those in the optical integrated device 1 of the first embodiment, explanation of duplicated components and actions thereof will be omitted. The gap Z between an input waveguide 11A1 and the first output waveguide 11C1 at the butt coupling point in the first chip 2 and the gap X between the input waveguide 23A and the first input waveguide 23B1 at the butt coupling point in the second chip 3 are made small. The butt coupling point is a portion at which the first chip 2 and the second chip 3 are optically coupled by butt coupling. The gap X between the input waveguide 11A1 and the first output waveguide 11C1 and the gap between the input waveguide 23A and the first input waveguide 23B1 are made small compared to a gap X1 between the optical fiber 4A on the input side and the optical fiber 4B on the output side.

When the second chip 3 is mounted face-down in the step portion 13 of the first chip 2, the first optical waveguide 11 of the first chip 2 and the second optical waveguide 23 of the second chip 3 are optically coupled using the adhesive A by butt coupling. That is, the input waveguide 11A1 of the input unit 14 in the first chip 2 and the input waveguide 23A of the first output unit 22A in the second chip 3 are optically coupled. The first output waveguide 11C1 of the first output unit 15A in the first chip 2 and the first input waveguide 23B1 of the second input unit 21B of the second chip 3 are optically connected. Furthermore, the second output waveguide 11C2 of the second output unit 15B in the first chip 2 and the second input waveguide 23B2 of the third input unit 21C of the second chip 3 are optically connected.

Because the gap X between the input waveguide 11A1 and the first output waveguide 11C1 of the first chip 2 is made small, the curvature radius of a folded waveguide 11B1 becomes small compared to the folded waveguide 11B illustrated in FIG. 1.

Because the gap between a input waveguide 23A1 and the output waveguide 23C in the second chip 3 is arranged to match the gap X1 between the optical fiber 4A on the input side and the optical fiber 4B on the output side of the optical fiber array 4, the input waveguide 23A1 in the second chip 3 is formed in a curved shape.

In the optical integrated device 1A according to the second embodiment, the gap X between the input waveguide 11A1 and the first output waveguide 11C1 at the butt coupling point of the first chip 2 is made small compared to the gap X1 between the optical fiber 4A on the input side and the optical fiber 4B on the output side of the optical fiber array 4. As a result, the tolerance for misalignment of the positioning angle of the second chip 3 when mounting the second chip 3 is increased, and the worsening of the coupling loss between the first optical waveguide 11 and the second optical waveguide 23 can be suppressed.

In the optical integrated device 1A according to the second embodiment, because the gap X between the input waveguide 11A1 and the first output waveguide 11C1 is made small, the curvature radium of the folded waveguide 11B1 becomes small. As a result, there is a risk of radiation loss occurring in the folded waveguide 11B1. Therefore, an embodiment to address such a situation will be described below as a third embodiment.

### (c) Third Embodiment

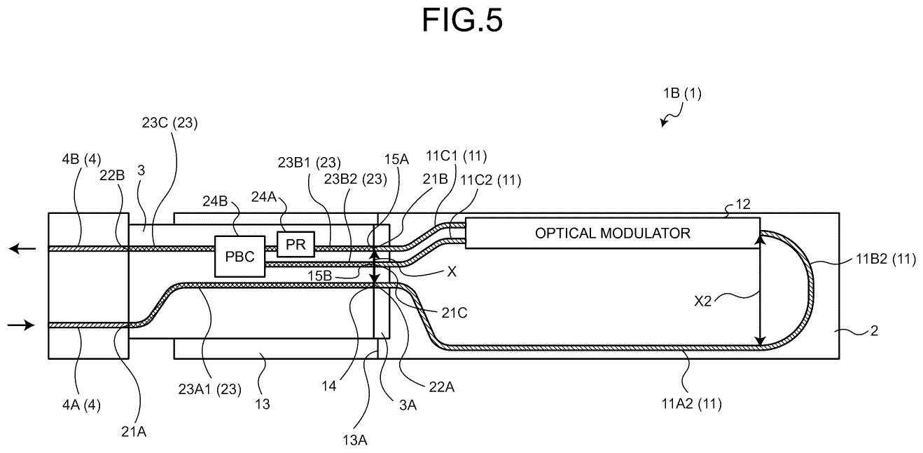

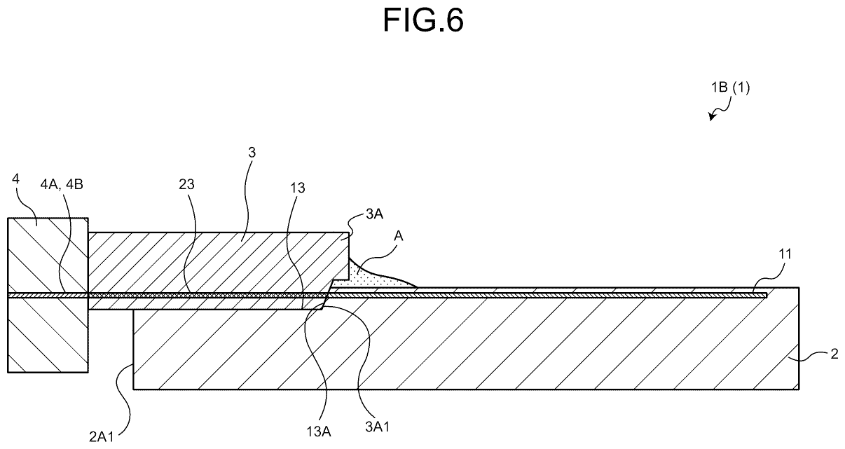

FIG. 5 is a plan schematic diagram illustrating an example of an optical integrated device 1B according to a third embodiment, and FIG. 6 is a simplified cross-section schematic diagram illustrating an example of the optical integrated device 1B. By assigning identical reference symbols to identical components to those in the optical integrated device 1A of the second embodiment, explanation of duplicated components and actions thereof will be omitted. A diameter of a folded waveguide 11B2 in the first chip 2 is large compared to a gap between an input waveguide 11A2 and the first output waveguide 11C1 at a butt coupling point in the first chip 2.

A diameter X2 of the folded waveguide 11B2 in the first chip 2 in the optical integrated device 1B according to the third embodiment is made large compared to the gap X between the input waveguide 11A2 and the first output waveguide 11C1 at the butt coupling point in the first chip 2. As a result, the curvature radius of the folded waveguide 11B2 becomes large and, therefore, the radiation loss in the folded waveguide 11B2 can be suppressed.

In the optical integrated device 1B of the third embodiment, an example in which the first inclined surface 13A is formed along an entire surface of an inner wall surface of the step portion 13 has been presented as an example, but it is not limited thereto, and an embodiment thereof will be explained below as a fourth embodiment.

### (d) Fourth Embodiment

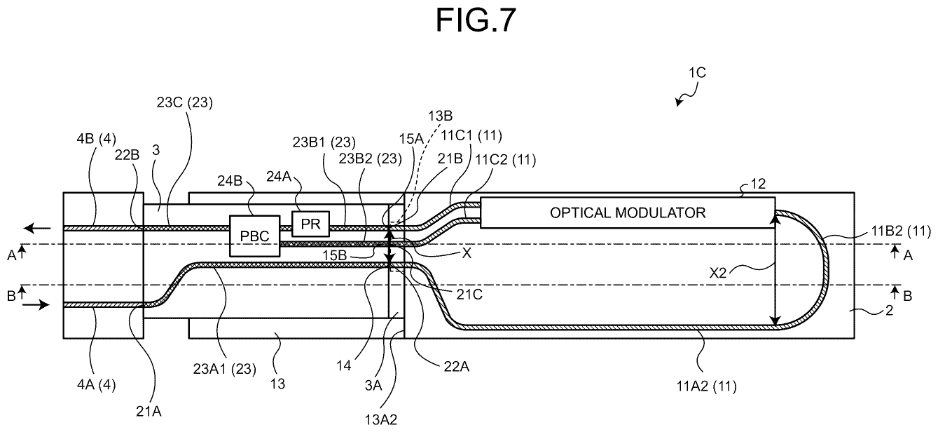

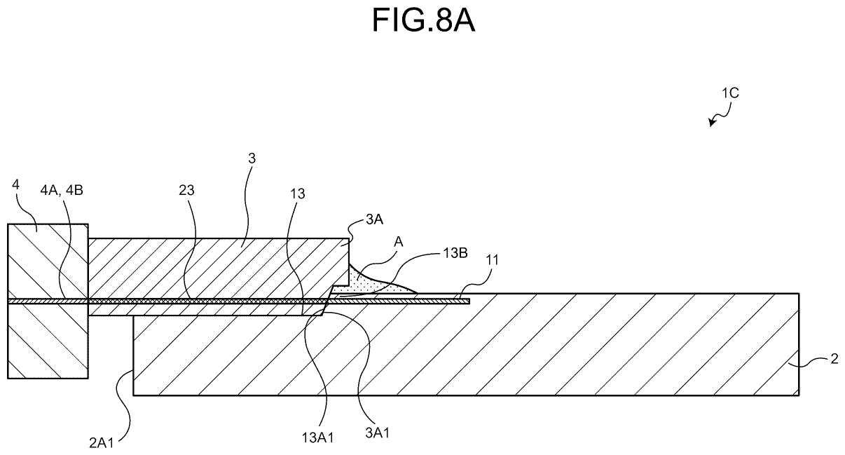

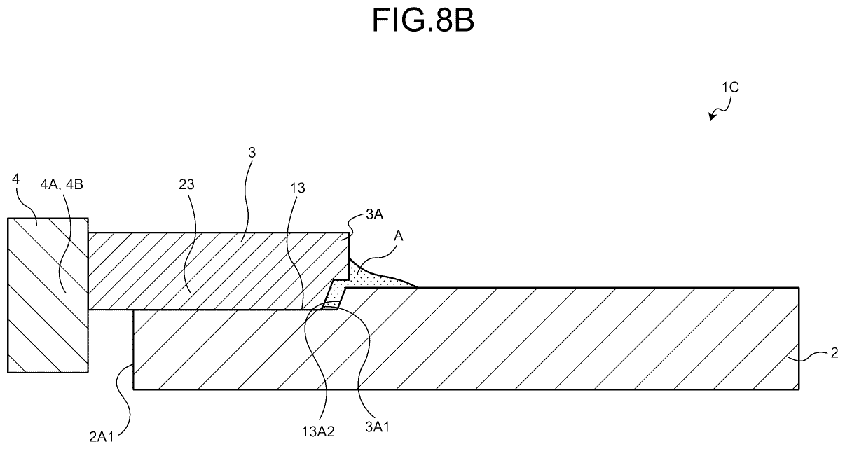

FIG. 7 is a plan schematic diagram illustrating an example of an optical integrated device 1C according to a fourth embodiment, FIG. 8A is a simplified cross-section schematic diagram taken along a line A-A in FIG. 7, and FIG. 8B is a simplified cross-section schematic diagram taken along a line B-B in FIG. 7. By assigning identical reference symbols to identical components to those in the optical integrated device 1A of the second embodiment, explanation of duplicated components and actions thereof will be omitted.

In the optical integrated device 1C, a protruding portion 13B in which portions corresponding to the input waveguide 11A1 of the input unit 14, the first output waveguide 11C1 of the first output unit 15A, and the second output waveguide 11C2 of the second output unit 15B out of the wall surface of the step portion 13 protrude out from the wall surface of the step portion 13 is provided. Out of the wall surface of the step portion 13, as illustrated in FIG. 8A, the protruding portion 13B includes a first inclined surface 13A1 abutting on the second inclined surface 3A1. Moreover, out of the wall surface of the step portion 13, a wall surface except the protruding portion 13B includes a third inclined surface 13A2 not in contact with the second inclined surface 3A1 as illustrated in FIG. 8B.

The input unit 14, the first output unit 15A, and the second output unit 15B are arranged on the first inclined surface 13A1 abutting on the second inclined surface 3A1. The first inclined surface 13A1 is a wall surface to which the input end of the input waveguide 11A extends. The first inclined surface 13A1 is a wall surface to which the output end of the first output waveguide 11C1 and the second output waveguide 11C2 extend.

When the second chip 3 is mounted face-down in the step portion 13 of the first chip 2, as illustrated in FIG. 8A, the second inclined surface 3A1 and the first inclined surface 13A1 are brought into contact. As a result, a gap between the first inclined surface 13A1 of the first chip 2 and the second inclined surface 3A1 of the second chip 3 becomes small. Subsequently, the first optical waveguide 11 of the first chip 2 and the second optical waveguide 23 of the second chip 3 are optically coupled by butt coupling using the adhesive A in a state in which the second inclined surface 3A1 and the first inclined surface 13A1 abut on each other. As a result, the input unit 14 in the first chip 2 and the first output unit 22A in the second chip 3 are optically connected. Furthermore, the first output unit 15A in the first chip 2 and the second input unit 21B of the second chip 3 are optically connected, and the second output unit 15B in the first chip 2 and the third input unit 21C of the second chip 3 are optically connected.

Moreover, when the second chip 3 is mounted face-down in the step portion 13 of the first chip 2, as illustrated in FIG. 8A, although a gap occurs between the distal-end step portion 3A and the protruding portion 13B of the first chip 2, the adhesive A is applied to the gap between the distal-end step portion 3A and the protruding portion 13B. As a result, the second chip 3 can be mounted in the step portion 13 of the first chip 2 using the adhesive A between the distal-end step portion 3A and the protruding portion 13B.

When the second chip 3 is mounted face-down in the step portion 13 of the first chip 2, as illustrated in FIG. 8B, although a gap occurs between the second inclined surface 3A1 and the third inclined surface 13A2, the adhesive A is applied to the gap between the second inclined surface 3A1 and the third inclined surface 13A2. As a result, the second chip 3 can be mounted within the step portion 13 of the first chip 2 using the adhesive A between the second inclined surface 3A1 and the third inclined surface 13A2.

In the optical integrated device 1C according to the fourth embodiment, the first optical waveguide 11 on the first inclined surface 13A and the second optical waveguide 23 on the second inclined surface 3A1 are optically coupled by butt coupling by using the adhesive A in a state in which the second inclined surface 3A1 and the first inclined surface 13A1 of the protruding portion 13B abut on each other. That is, the gap between the second optical waveguide 23 on the second inclined surface 3A1 and the first optical waveguide 11 on the first inclined surface 13A1 becomes small. As a result, the optical coupling efficiency between the second optical waveguide 23 and the first optical waveguide 11 can be improved.

In the optical integrated device 1B according to the third embodiment, a case in which the second inclined surface 3A1 is formed along an entire surface facing the wall surface of the step portion 13 at a lower portion of the distal-end step portion 3A of the second chip 3 has been presented as an example. However, it is not limited thereto, and an embodiment thereof will be explained below as a fifth embodiment.

### (e) Fifth Embodiment

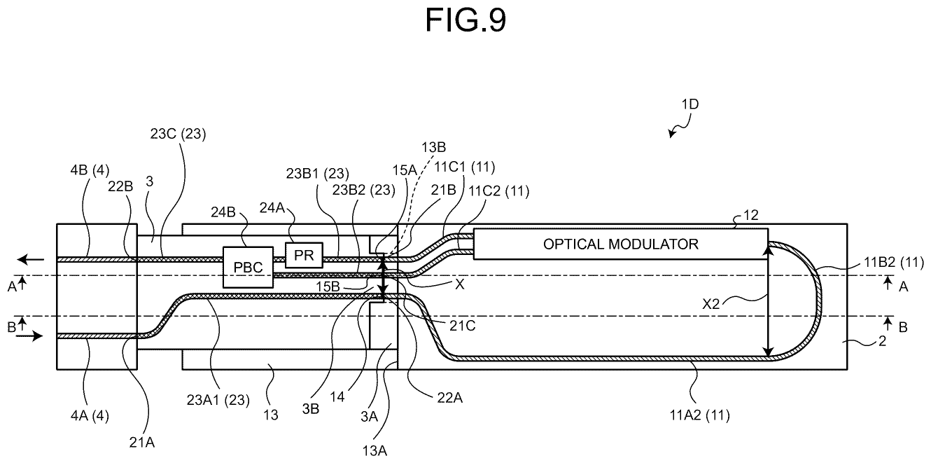

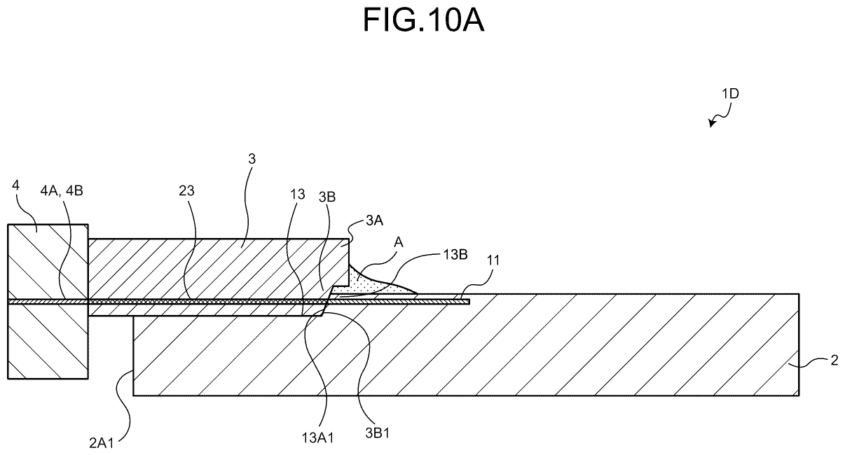

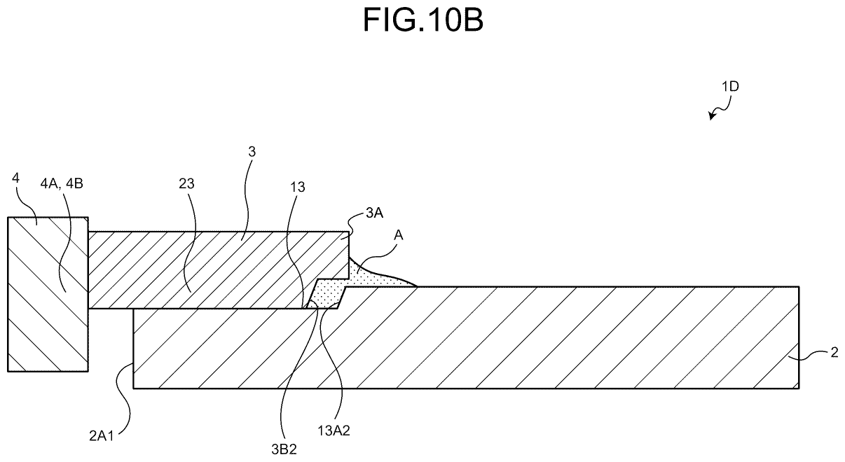

FIG. 9 is a plan schematic diagram illustrating an example of an optical integrated device 1D according to a fifth embodiment, FIG. 10A is a simplified cross-section schematic diagram taken along a line A-A in FIG. 9, and FIG. 10B is a simplified cross-section schematic diagram taken along a line B-B in FIG. 9. By assigning identical reference symbols to identical components to those in the optical integrated device 1C of the fourth embodiment, explanation of duplicated components and actions thereof will be omitted.

The optical integrated device 1D includes a protruding portion 3B in which portions corresponding to the input waveguide 23A of the first output unit 22A, the first input waveguide 23B1 of the second input unit 21B, and the second input waveguide 23B2 of the third input unit 21C protrude from an inner wall surface out of the inner wall surface at a lower portion of the distal-end step portion 3A. Out of the inner wall surface of the distal-end step portion 3A, as illustrated in FIG. 10A, the protruding portion 3B includes a second inclined surface 3B1 abutting on the first inclined surface 13A1 of the protruding portion 13B in the step portion 13. Moreover, out of the inner wall surface of the distal-end step portion 3A, an inner wall surface except the protruding portion 3B includes a fourth inclined surface 3B2 not in contact with the third inclined surface 13A2 in the step portion 13.

The first output unit 22A, the second input unit 21B, and the third input unit 21C are arranged on the second inclined surface 3B1 abutting on the first inclined surface 13A1 of the protruding portion 13B in the step portion 13. The second inclined surface 3B1 is a wall surface to which the output end of the input waveguide 23A extends. The second inclined surface 3B1 is a wall a wall surface to which the first input waveguide 23B1 and the input end of the second input waveguide 23B2 extend.

When the second chip 3 is mounted face-down in the step portion 13 of the first chip 2, as illustrated in FIG. 10A, the second inclined surface 3B1 and the first inclined surface 13A1 are brought into contact. As a result, a gap between the first inclined surface 13A1 of the first chip 2 and the second inclined surface 3B1 of the second chip 3 becomes small. Subsequently, the first optical waveguide 11 of the first chip 2 and the second optical waveguide 23 of the second chip 3 are optically coupled by butt coupling using the adhesive A in a state in which the second inclined surface 3B1 and the first inclined surface 13A1 abut on each other. As a result, the input unit 14 in the first chip 2 and the first output unit 22A in the second chip 3 are optically connected. Furthermore, the first output unit 15A in the first chip 2 and the second input unit 21B of the second chip 3 are optically connected, and the second output unit 15B in the first chip 2 and the third input unit 21C of the second chip 3 are optically connected.

Moreover, when the second chip 3 is mounted face-down in the step portion 13 of the first chip 2, as illustrated in FIG. 10A, although a gap occurs between the distal-end step portion 3A and the chip end surface of the first chip 2, the adhesive A is applied to the gap between the distal-end step portion 3A and the chip end surface. As a result, the second chip 3 can be mounted in the step portion 13 of the first chip 2 using the adhesive A between the distal-end step portion 3A and the chip end surface.

When the second chip 3 is mounted face-down in the step portion 13 of the first chip 2, as illustrated in FIG. 10B, although a gap occurs between the fourth inclined surface 3B2 and the third inclined surface 13A2, the adhesive A is applied to the gap between the fourth inclined surface 3B2 and the third inclined surface 13A2. As a result, the second chip 3 can be mounted in the step portion 13 of the first chip 2 using the adhesive A between the fourth inclined surface 3B2 and the third inclined surface 13A2.

In the optical integrated device 1D according to the fifth embodiment, the first optical waveguide 11 on the first inclined surface 13A1 and the second optical waveguide 23 on the second inclined surface 3B1 are optically coupled by butt coupling by using the adhesive A in a state in which the second inclined surface 3B1 of the protruding portion 3B and the first inclined surface 13A1 of the protruding portion 13B abut on each other. That is, the gap between the second optical waveguide 23 on the second inclined surface 3B1 and the first optical waveguide 11 on the first inclined surface 13A1 becomes small. As a result, the optical coupling efficiency between the second optical waveguide 23 and the first optical waveguide 11 can be improved.

In the optical integrated device 1D according to the fifth embodiment, a case in which the first optical waveguide 11 of the first inclined surface 13A1 and the second optical waveguide 23 of the second inclined surface 3B1 are optically coupled by butt coupling in a state in which the second inclined surface 3B1 of the protruding portion 3B and the first inclined surface 13A1 of the protruding portion 13B abut on each other has been presented as an example. However, the first optical waveguide 11 of the first inclined surface 13A1 and the second optical waveguide 23 of the second inclined surface 3B1 may be optically coupled by butt coupling in a state in which the second inclined surface 3B1 of the protruding portion 3B of the second chip 3 abuts on the first inclined surface 13A on the wall surface of the step portion 13 of the first chip 2, and it may be modified as appropriate.

The waveguide, such as the first optical waveguide 11 and the second optical waveguide 23, may be, for example, a rib waveguide, a ridge waveguide, a rectangular waveguide, or a high-mesa waveguide. The rib waveguide is preferable because light leaks into the slab region, making it less susceptible to be affected by sidewall roughness of a core, and enabling low-loss propagation. The rectangular waveguide is preferable because of its strong light confinement, and a loss is small even when a bending radius R is small. Moreover, for the waveguide, a low-loss curved waveguide may be used, and it may be modified as appropriate.

The second optical waveguide 23 may be a PLC in which both a core and a cladding are made of SiO₂, an InP waveguide, or a GaAs waveguide. It may be an Si waveguide with a core made of Si, a lower cladding made of SiO₂, and an upper cladding made of SiO₂, air, SiN or the like. When the waveguide is an Si waveguide, it is preferable because a refractive index difference is large and, therefore, light confinement is strong, and a curved waveguide with a low loss even with a small bending radius R can be achieved, that is, downsizing of an optical device is possible.

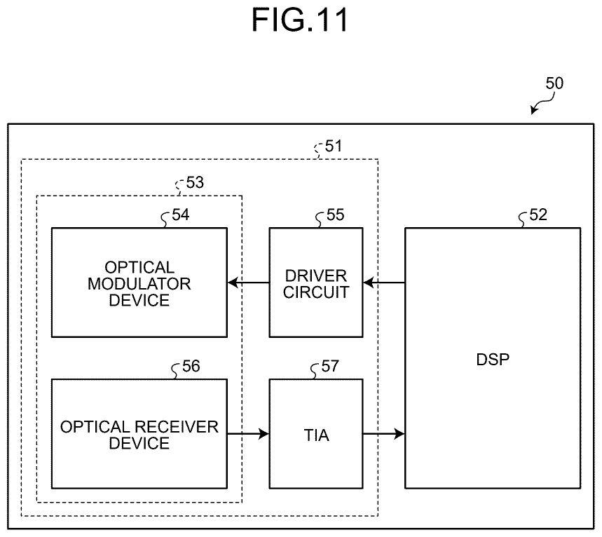

Next, an optical transceiver 50 using the optical integrated device 1 according to the present embodiment will be explained. FIG. 11 is an explanatory diagram illustrating an example of the optical transceiver 50 according to the present embodiment. The optical transceiver 50 illustrated in FIG. 11 includes an optical transceiving device 51, and a digital signal processor (DSP) 52. The optical transceiving device 51 includes an optical modulator device 54 in an optical module 53, a driver circuit 55, an optical receiver device 56 in the optical module 53, and a transimpedance amplifier (TIA) 57. The DSP 52 controls the entire optical transceiving device 51. The DSP 52 is an electrical component that performs digital signal processing including IP modulation processing of a transmission signal, and demodulation processing of a reception signal.

The DSP 52 performs processing, such as encoding of transmission data, generates an electrical signal including the transmission data, and outputs the generated electrical signal to the driver circuit 55. The driver circuit 55 drives the optical modulator device 54 according to the electrical signal from the DSP 52. The optical modulator device 54 is equipped with the optical integrated device 1 including the optical modulator that optically modulates a signal light.

The optical receiver device 56 electrically converts the signal light. The TIA 57 amplifies the electrical signal subjected to electrical conversion, and outputs the amplified electrical signal to the DSP 52. The DSP 52 performs processing, such as decoding of the electrical signal acquired from the TIA 57, to obtain reception data.

For convenience of explanation, a case in which the optical transceiver 50 has the optical modulator device 54 and the optical receiver device 56 therein has been presented as an example, but the optical transceiver 50 may be an optical transmission device that has only the optical modulator device 54 therein, and it may be modified as appropriate.

Furthermore, the illustrated respective components of the respective parts are not necessarily configured physically as illustrated. That is, specific forms of distribution and integration of the respective devices are not limited to the ones illustrated, and all or some thereof can be configured to be distributed or integrated functionally or physically in arbitrary units according to various kinds of loads, usage conditions, and the like.

Furthermore, as for the respective processing functions performed by the respective devices, all or an arbitrary part thereof can be implemented on a central processing unit (CPU) (or a microcomputer, such as a micro processing unit (MPU) and a micro controller unit (MCU)). Moreover, it is needless to say that the respective processing functions may be implemented such that all or an arbitrary part thereof is performed on a computer program analyzed and executed by the CPU (or a microcomputer, such as an MPU and an MCU), or on hardware by wired logic.

According to one aspect, a work load for implementation of a chip equipped with an optical waveguide having an electro-optic effect can be reduced.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An optical integrated device comprising:
a first chip having a step portion; and
a second chip that is mounted on the step portion, and that is optically connected to the first chip, wherein
the first chip includes an optical waveguide including a material having a high electro-optic effect compared to a material of the second chip, and
the optical integrated device includes
a first inclined surface that is formed on a wall surface on a side on which the optical waveguide and the second chip are optically connected in the step portion, and
a second inclined surface that is formed on an end surface of the second chip on a side on which it is mounted within the step portion, and that abuts on the first inclined surface facing the first inclined surface.

2. The optical integrated device according to claim 1, wherein
the first chip includes a first optical waveguide that is the optical waveguide extending to the first inclined surface,
the second chip includes a second optical waveguide extending to the second inclined surface, and
the first optical waveguide and the second optical waveguide are optically coupled by butt coupling by bringing the first inclined surface and the second inclined surface into contact.

3. The optical integrated device according to claim 1, wherein
the first chip includes a protruding portion that protrudes out from a wall surface optically connected to the second chip in the step portion, and the first inclined surface is formed on the protruding portion.

4. The optical integrated device according to claim 1, wherein
the second chip includes a protruding portion that protrudes out from a wall surface in an end surface of the second chip, the wall surface optically connected to the first chip, and the second inclined surface is formed in the protruding portion.

5. The optical integrated device according to claim 1, wherein the second chip is mounted face-down on the step portion formed on the first chip.

6. The optical integrated device according to claim 1, wherein the first chip includes a material of thin LN (LiNbO₃) crystal, and includes an optical modulator that is optically connected to the optical waveguide.

7. The optical integrated device according to claim 6, wherein
the second chip has a material of silicon, and includes an optical circuit, and
the optical circuit includes
a polarization rotator that polarization-rotates a signal light from the optical modulator; and
a polarization multiplexer that polarization-multiplexes the signal light from the optical modulator and the signal light subjected to polarization rotation by the polarization rotator.

8. The optical integrated device according to claim 2, wherein
the first optical waveguide in the first chip includes
a first input waveguide optically connected to the second chip;
a folded waveguide that connects between the first input waveguide and the optical modulator in a folded manner; and
a first output waveguide that is connected to the optical modulator and is connected to the second chip.

9. The optical integrated device according to claim 8, wherein it is configured such that the folded waveguide has a diameter larger than a gap between the first input waveguide and the first output waveguide at a joining point at which the first chip and the second chip are butt-coupled.

10. The optical integrated device according to claim 8, wherein
the second optical waveguide in the second chip includes
a second input waveguide that connects between an optical fiber on an input side and the first input waveguide; and
a second output waveguide that connects between an optical fiber on an output side and the first output waveguide, and
it is configured such that a gap between the first input waveguide and the first output waveguide at a joining point at which the first chip and the second chip are butt-coupled is smaller than a gap between the second input waveguide and the second output waveguide at a joining surface between the optical fiber on the input side and the optical fiber on the output side.

11. An optical transmission device comprising
an optical modulator device that modulates light using an electrical signal to transmit a transmission light, wherein
the optical modulator device includes
a first chip having a step portion; and
a second chip that is mounted on the step portion, and that is optically connected to the first chip,
the first chip includes an optical waveguide including a material having a high electro-optic effect compared to a material of the second chip, and
the optical modulator device includes
a first inclined surface that is formed on a wall surface on a side on which the optical waveguide and the second chip are optically connected in the step portion, and
a second inclined surface that is formed on an end surface of the second chip on a side on which it is mounted within the step portion, and that abuts on the first inclined surface facing the first inclined surface.

12. An optical transceiver comprising:
an optical modulator device that optically modulates light using a transmission signal, to transmit a transmission light; and
an optical receiver device that receives a reception signal from a reception light using light, wherein
the optical modulator includes
a first chip having a step portion;
a second chip that is mounted on the step portion, and that is optically connected to the first chip,
the first chip includes an optical waveguide including a material having a high electro-optic effect compared to a material of the second chip, and
the optical modulator device includes
a first inclined surface that is formed on a wall surface on a side on which the optical waveguide and the second chip are optically connected in the step portion, and
a second inclined surface that is formed on an end surface of the second chip on a side on which it is mounted within the step portion, and that abuts on the first inclined surface facing the first inclined surface.
